(19) United States
(12) Patent Application Publication
(10) Pub. No.: US 2017/0039141 A1
(43) Pub. Date: Feb. 9, 2017

(54) MAPPING TABLE UPDATING METHOD, MEMORY STORAGE DEVICE AND MEMORY CONTROL CIRCUIT UNIT

(71) Applicant: PHISON ELECTRONICS CORP., Miaoli (TW)

(72) Inventors: Chih-Kang Yeh, Kinmen County (TW); Yi-Hsien Lin, New Taipei City (TW)

(21) Appl. No.: 14/842,836

(22) Filed: Sep. 2, 2015

(30) Foreign Application Priority Data
Aug. 4, 2015 (TW) 104125306

(51) Int. Cl. G06F 12/10; G06F 3/06

(52) U.S. Cl. CPC G06F 12/1009; G06F 3/0608; G06F 3/0656; G06F 3/0679; G06F 2212/2022; G06F 2212/7201

(57) ABSTRACT

A mapping table updating method, a memory storage device and a memory control circuit unit are provided. The method includes: receiving a write command; recording physical-to-logical mapping information of write data corresponding to the write command into a first mapping table in a buffer memory; storing the physical-to-logical mapping information of the write data into a physical unit in a rewritable non-volatile memory module according to the first mapping table; updating the physical-to-logical mapping information of the write data recorded in the first mapping table, where the updated physical-to-logical mapping information only includes partial information of the physical-to-logical mapping information; and updating a second mapping table according to the updated physical-to-logical mapping information recorded in the first mapping table. Accordingly, the usage space of the first mapping table may be saved.

### CROSS-REFERENCE TO RELATED APPLICATION

This application claims the priority benefit of Taiwan application serial no. 104125306, filed on Aug. 4, 2015. The entirety of the above-mentioned patent application is hereby incorporated by reference herein and made a part of this specification.

### BACKGROUND

Technical Field

The disclosure relates a memory management mechanism, and more particularly, to a mapping table updating method, a memory storage device and a memory control circuit unit.

Description of Related Art

The markets of digital cameras, cellular phones, and MP3 players have expanded rapidly in recent years, resulting in escalated demand for storage media by consumers. The characteristics of data non-volatility, low power consumption, and compact size make a rewritable non-volatile memory module (e.g., flash memory) ideal to be built in the portable multi-media devices as cited above.

In general, a memory storage device using the rewritable non-volatile memory module accesses data by looking up or modifying a logical-to-physical mapping table which is configured to record mapping relations (i.e., logical-to-physical mapping relations) between logical addresses and physical addresses. When the logical-to-physical mapping relation of one specific logical address in the logical-to-physical mapping table is changed, it is required to read the related logical-to-physical mapping table into a buffer memory of the memory storage device in order to update the related logical-to-physical mapping table and store the updated logical-to-physical mapping table back into the rewritable non-volatile memory module.

However, the logical-to-physical mapping table being accessed too frequently may lead to reduction in a lifetime of the rewritable non-volatile memory module. Therefore, for specific types of the memory storage device, a physical-to-logical mapping table is further introduced. For example, when one specific data from a host system is stored into the memory storage device, physical-to-logical mapping information related to the data is recorded into one physical-to-logical mapping table in the buffer memory first and then information in the physical-to-logical mapping table are stored together with the corresponding data into the rewritable non-volatile memory module. Later, when one specific physical-to-logical mapping table in the buffer memory is fully written, information recorded in the physical-to-logical mapping table are used to update the logical-to-physical mapping table. Accordingly, the number of times for reading and storing back the logical-to-physical mapping table may be reduced.

However, in some specific circumstances, if the logical-to-physical mapping information of one specific logical address to be accessed based on instruction of the host system is already stored in the buffer memory, the logical-to-physical mapping information of the logical address may be directly updated in the buffer memory at the time. As such, it is obviously unnecessary to continuously maintain the physical-to-logical mapping information of such logical address in the buffer memory since it may result in unnecessary wastage of spaces in the buffer memory.

Nothing herein should be construed as an admission of knowledge in the prior art of any portion of the present disclosure. Furthermore, citation or identification of any document in this application is not an admission that such document is available as prior art to the present disclosure, or that any reference forms a part of the common general knowledge in the art.

### SUMMARY

Accordingly, the disclosure is directed to a mapping table updating method, a memory storage device and a memory control circuit unit, which are capable of adaptively updating unnecessary physical-to-logical mapping information in the buffer memory, so as to save spaces for the buffer memory.

An exemplary embodiment of the disclosure provides a mapping table updating method for a rewritable non-volatile memory module, and the mapping table updating method includes: receiving a write command and write data corresponding to the write command; recording physical-to-logical mapping information corresponding to the write data into a first mapping table temporarily stored in a buffer memory; storing the physical-to-logical mapping information corresponding to the write data into a physical unit in the rewritable non-volatile memory module according to the first mapping table, wherein the physical unit is stored with at least partial data of the write data; updating the physical-to-logical mapping information corresponding to the write data recorded in the first mapping table temporarily stored in the buffer memory, wherein the updated physical-to-logical mapping information only includes partial information of the physical-to-logical mapping information corresponding to the write data; and updating a second mapping table according to the updated physical-to-logical mapping information recorded in the first mapping table.

Another exemplary embodiment of the disclosure provides a memory storage device, which includes a connection interface unit, a rewritable non-volatile memory module and a memory control circuit unit. The connection interface unit is configured to couple to a host system. The memory control circuit unit is coupled to the connection interface unit and the rewritable non-volatile memory module. The memory control circuit unit is configured to receive a write command and write data corresponding to the write command. The memory control circuit unit is further configured to record physical-to-logical mapping information corresponding to the write data into a first mapping table temporarily stored in a buffer memory. The memory control circuit unit is further configured to send a write command sequence according to the first mapping table temporarily stored in the buffer memory to instruct for storing the physical-to-logical mapping information corresponding to the write data into a physical unit in the rewritable non-volatile memory module, wherein the physical unit is stored with at least partial data of the write data. The memory control circuit unit is further configured to update the physical-to-logical mapping information corresponding to the write data recorded in the first mapping table temporarily stored in the buffer memory. The updated physical-to-logical mapping information only includes partial information of the physical-to-logical mapping information corresponding to the write data. The memory control circuit unit is further configured to update a second mapping table according to the updated physical-to-logical mapping information recorded in the first mapping table.

Another exemplary embodiment of the disclosure provides a memory control circuit unit, which is configured to control a rewritable non-volatile memory module. The memory control circuit unit includes a host interface, a memory interface, a buffer memory and a memory management circuit. The host interface is configured to couple to a host system. The memory interface is configured to couple to a rewritable non-volatile memory module. The memory management circuit is coupled to the host interface, the memory interface and the buffer memory. The memory management circuit is configured to receive a write command and write data corresponding to the write command. The memory management circuit is further configured to record physical-to-logical mapping information corresponding to the write data into a first mapping table temporarily stored in the buffer memory. The memory management circuit is further configured to send a write command sequence according to the first mapping table temporarily stored in the buffer memory to instruct for storing the physical-to-logical mapping information corresponding to the write data into a physical unit in the rewritable non-volatile memory module, wherein the physical unit is stored with at least partial data of the write data. The memory management circuit is further configured to update the physical-to-logical mapping information corresponding to the write data recorded in the first mapping table temporarily stored in the buffer memory. The updated physical-to-logical mapping information only includes partial information of the physical-to-logical mapping information corresponding to the write data. The memory management circuit is further configured to update a second mapping table according to the updated physical-to-logical mapping information recorded in the first mapping table.

Based on the above, after storing the physical-to-logical mapping information of one specific write data from the buffer memory into the rewritable non-volatile memory module, the physical-to-logical mapping information of the specific write data is updated in the buffer memory so as to attempt for releasing more available spaces in the buffer memory.

To make the above features and advantages of the present disclosure more comprehensible, several embodiments accompanied with drawings are described in detail as follows.

It should be understood, however, that this Summary may not contain all of the aspects and embodiments of the present disclosure, is not meant to be limiting or restrictive in any manner, and that the disclosure as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating a host system and a memory storage device according to an exemplary embodiment of the disclosure.

FIG. 2 is a schematic diagram of a computer, an input/output device, and a memory storage device according to an exemplary embodiment of the disclosure.

FIG. 3 is a schematic diagram illustrating a host system and a memory storage device according to an exemplary embodiment of the disclosure.

FIG. 4 is a schematic block diagram illustrating the memory storage device depicted in FIG. 1.

FIG. 5 is a schematic block diagram illustrating a rewritable non-volatile memory module according to an exemplary embodiment of the disclosure.

FIG. 6 is a schematic diagram illustrating a memory cell array according to an exemplary embodiment of the disclosure.

FIG. 7 is a schematic block diagram illustrating a memory control circuit unit according to an exemplary embodiment of the disclosure.

FIG. 8 is a schematic diagram illustrating management of a rewritable non-volatile memory module according to an exemplary embodiment of the disclosure.

FIG. 9 to FIG. 13 are schematic diagrams illustrating operations of updating the mapping table according to an exemplary embodiment of the disclosure.

FIG. 14 is a schematic diagram illustrating use of the reserved area for updating the first mapping table according to an exemplary embodiment of the disclosure.

FIG. 15 is a schematic diagram illustrating an operation of removing the physical-to-logical mapping information in order to update the first mapping table according to an exemplary embodiment of the disclosure.

FIG. 16 is a schematic diagram illustrating an operation of removing the physical-to-logical mapping information in order to update the first mapping table according to another exemplary embodiment of the disclosure.

FIG. 17 is a schematic diagram illustrating an operation of updating the second mapping table according to an exemplary embodiment of the disclosure.

FIG. 18 is a flowchart illustrating a mapping table updating method according to an exemplary embodiment of the disclosure.

FIG. 19 is a flowchart illustrating a mapping table updating method according to another exemplary embodiment of the disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

Embodiments of the present disclosure may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” may be used interchangeably herein.

Generally, the memory storage device (also known as a memory storage system) includes a rewritable non-volatile memory module and a controller (also known as a control circuit). The memory storage device is usually configured together with a host system so that the host system may write data into the memory storage device or read data from the memory storage device.

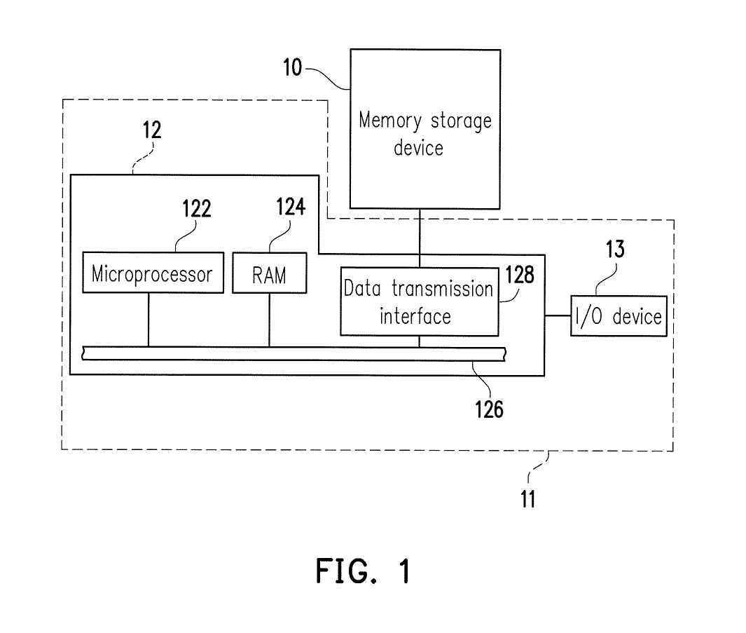

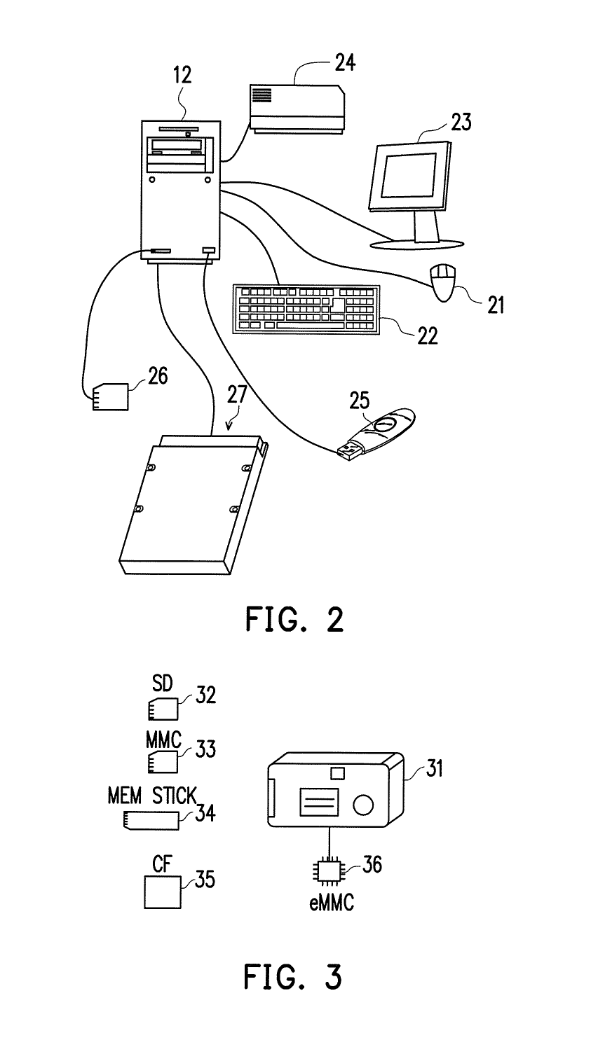

FIG. 1 is a schematic diagram illustrating a host system and a memory storage device according to an exemplary embodiment of the disclosure. FIG. 2 is a schematic diagram of a computer, an input/output device, and a memory storage device according to an exemplary embodiment of the disclosure.

Referring to FIG. 1, a host system 11 includes a computer 12 and an input/output (I/O) device 13. The computer 12 includes a microprocessor 122, a random access memory (RAM) 124, a system bus 126, and a data transmission interface 128. The I/O device 13 includes a mouse 21, a keyboard 22, a display 23 and a printer 24 as shown in FIG. 2. It should be understood that the devices illustrated in FIG. 2 are not intended to limit the I/O device 13, and the I/O device 13 may further include other devices.

In an exemplary embodiment, the memory storage device 10 is coupled to other devices of the host system 11 through the data transmission interface 128. By using the microprocessor 122, the random access memory 124 and the Input/Output (I/O) device 13, data may be written into the memory storage device 10 or may be read from the memory storage device 10. For example, the memory storage device 10 may be a rewritable non-volatile memory storage device such as a flash drive 25, a memory card 26, or a solid state drive (SSD) 27 as shown in FIG. 2.

FIG. 3 is a schematic diagram illustrating a host system and a memory storage device according to an exemplary embodiment of the disclosure.

Generally, the host system 11 may substantially be any system capable of storing data with the memory storage device 10. Even though the host system 11 is illustrated as a computer system in the present exemplary embodiment, however, in another exemplary embodiment of the present disclosure, the host system 11 may be a digital camera, a video camera, a telecommunication device, an audio player, or a video player. For example, when the host system is a digital camera (video camera) 31, the rewritable non-volatile memory storage device may be a SD card 32, a MMC card 33, a memory stick 34, a CF card 35 or an embedded storage device 36 (as shown by FIG. 3). The embedded storage device 36 includes an embedded MMC (eMMC). It should be mentioned that the eMMC is directly coupled to a substrate of the host system.

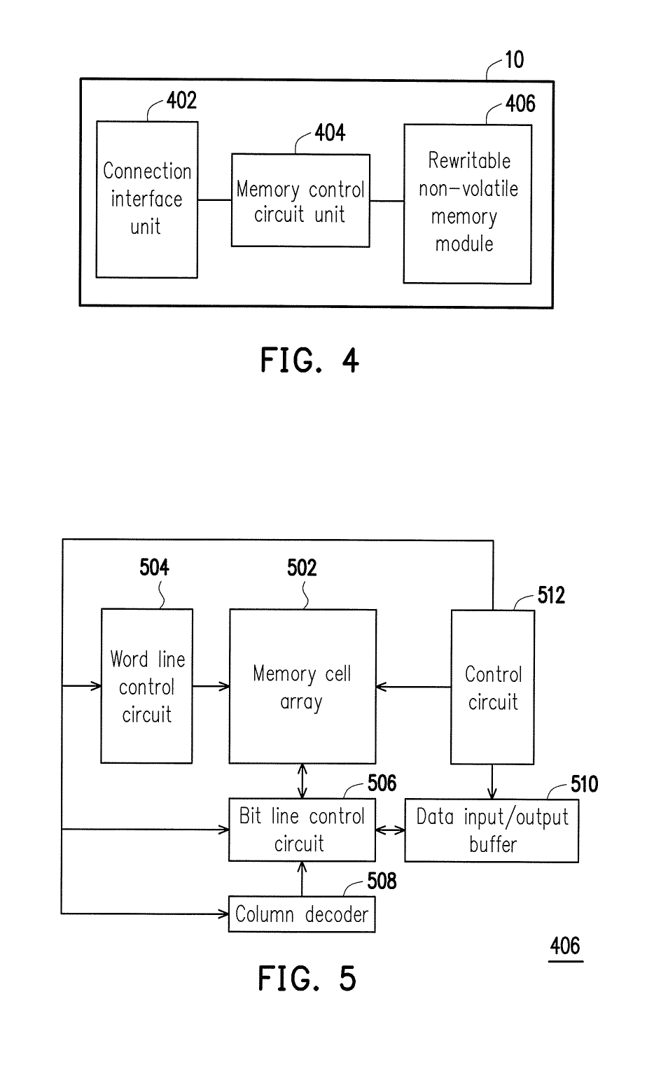

FIG. 4 is a schematic block diagram illustrating the memory storage device depicted in FIG. 1.

Referring to FIG. 4, the memory storage device 10 includes a connection interface unit 402, a memory control circuit unit 404 and a rewritable non-volatile memory module 406.

In the present exemplary embodiment, the connection interface unit 402 is compatible with a serial advanced technology attachment (SATA) standard. However, the disclosure is not limited thereto, and the connection interface unit 402 may also be compatible to a Parallel Advanced Technology Attachment (PATA) standard, an Institute of Electrical and Electronic Engineers (IEEE) 1394 standard, a peripheral component interconnect (PCI) Express interface standard, a universal serial bus (USB) standard, a secure digital (SD) interface standard, a Ultra High Speed-I (UHS-I) interface standard, a Ultra High Speed-II (UHS-II) interface standard, a memory sick (MS) interface standard, a multi media card (MMC) interface standard, an embedded MMC (eMMC) interface standard, a Universal Flash Storage (UFS) interface standard, a compact flash (CF) interface standard, an integrated device electronics (IDE) interface standard or other suitable standards. The connection interface unit 402 and the memory control circuit unit 404 may be packaged into one chip, or the connection interface unit 402 is distributed outside of a chip containing the memory control circuit unit 404.

The memory control circuit unit 404 is configured to execute a plurality of logic gates or control commands which are implemented in a hardware form or in a firmware form and execute operations of writing, reading or erasing data in the rewritable non-volatile memory storage module 406 according to the commands of the host system 11.

The rewritable non-volatile memory module 406 is coupled to the memory control circuit unit 404 and configured to store data written from the host system 11. The rewritable non-volatile memory module 406 may be a Single Level Cell (SLC) NAND flash memory module (i.e., a flash memory module capable of storing one bit data in one memory cell), a Multi Level Cell (MLC) NAND flash memory module (i.e., a flash memory module capable of storing two bit data in one memory cell), a Triple Level Cell (TLC) NAND flash memory module (i.e., a flash memory module capable of storing three bit data in one memory cell), other flash memory modules or any memory module having the same features.

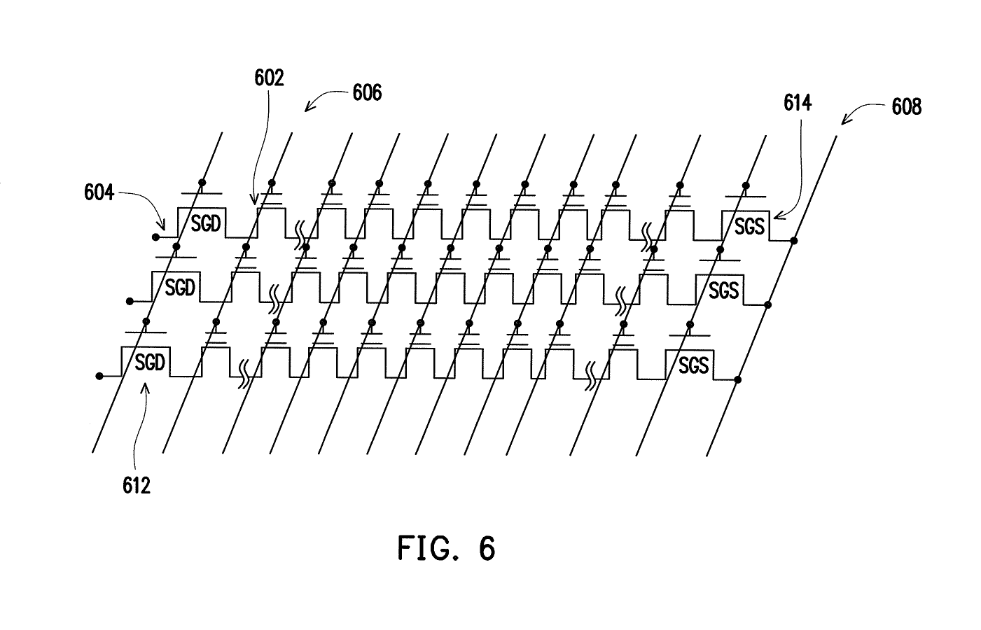

FIG. 5 is a schematic block diagram illustrating a rewritable non-volatile memory module according to an exemplary embodiment of the disclosure. FIG. 6 is a schematic diagram illustrating a memory cell array according to an exemplary embodiment of the disclosure.

Referring to FIG. 5, the rewritable non-volatile memory module 406 includes a memory cell array 502, a word line control circuit 504, a bit line control circuit 506, a column decoder 508, a data input-output buffer 510 and a control circuit 512.

In the present exemplary embodiment, the memory cell array 502 may include a plurality of memory cells 602 used to store data, a plurality of select gate drain (SGD) transistors 612, a plurality of select gate source (SGS) transistors 614, as well as a plurality of bit lines 604, a plurality of word lines 606, a common source line 608 connected to the memory cells (as shown in FIG. 6). The memory cell 602 is disposed at intersections of the bit lines 604 and the word lines 606 in a matrix manner (or in a 3D stacking manner). When a write command or a read command is received from the memory control circuit unit 404, the control circuit 512 controls the word line control circuit 504, the bit line control circuit 506, the column decoder 508, the data input-output buffer 510 to write the data into the memory cell array 502 or read the data from the memory cell array 502, wherein the word line control circuit 504 is configured to control voltages applied to the word lines 606, the bit line control circuit 506 is configured to control voltages applied to the bit lines 604, the column decoder 508 is configured to select the corresponding bit line according to a row address in a command, and the data input/output buffer 510 is configured to temporarily store the data.

Each of the memory cells in the rewritable non-volatile memory module 406 may store one or more bits by changing a threshold voltage of the memory cell. More specifically, in each of the memory cells, a charge trapping layer is provided between a control gate and a channel. Amount of electrons in the charge trapping layer may be changed by applying a write voltage to the control gate thereby changing the threshold voltage of the memory cell. This process of changing the threshold voltage is also known as “writing data into the memory cell” or “programming the memory cell”. Each of the memory cells in the memory cell array 502 has a plurality of storage statuses depended on changes in the threshold voltage. Moreover, which of the storage statuses is the memory cell belongs to may be determined by read voltages, so as to obtain the one or more bits stored in the memory cell.

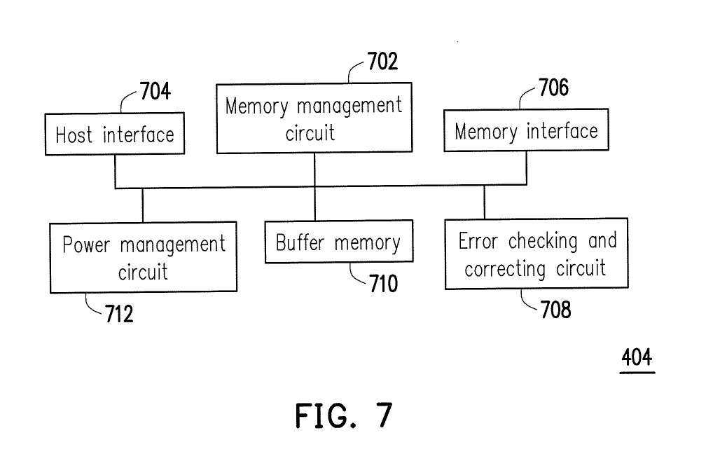

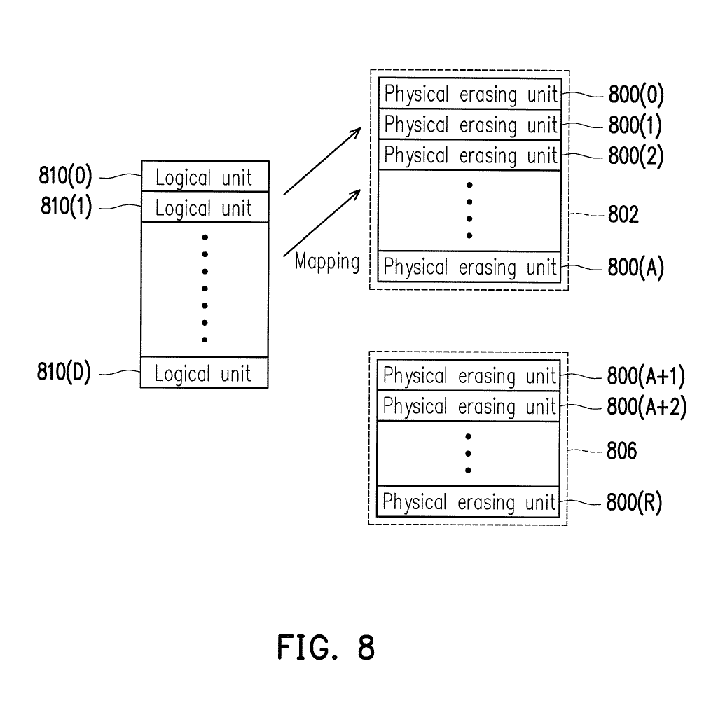

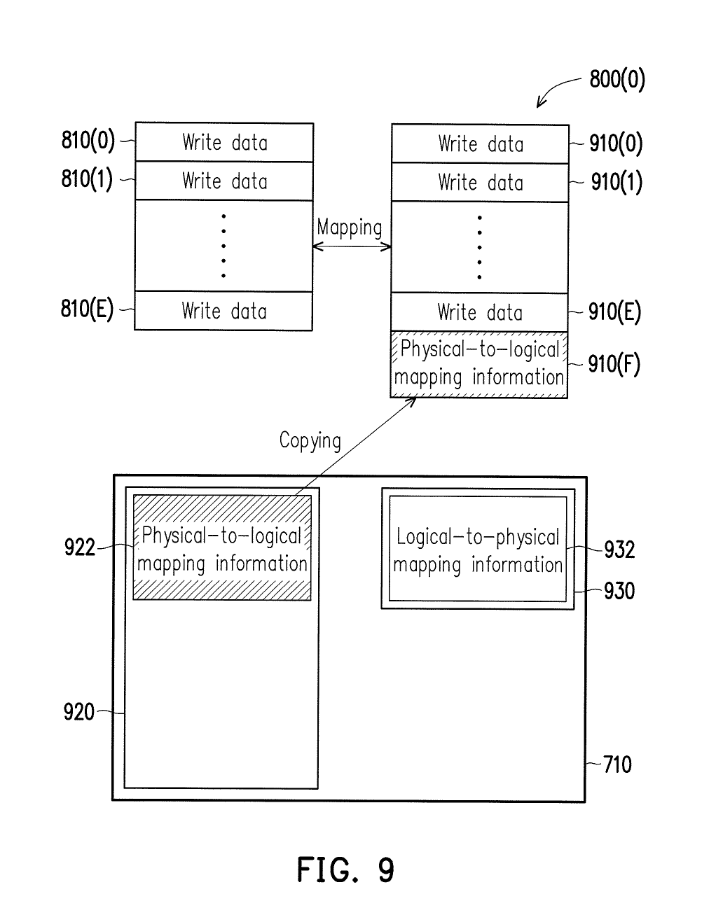

FIG. 7 is a schematic block diagram illustrating a memory control circuit unit according to an exemplary embodiment of the disclosure.

Referring to FIG. 7, the memory control circuit unit 404 includes a memory management circuit 702, a host interface 704, a memory interface 706, an error checking and correcting circuit 708 and a buffer memory 710.

The memory management circuit 702 is configured to control overall operations of the memory control circuit unit 404. Specifically, the memory management circuit 702 has a plurality of control commands. During operations of the memory storage device 10, the control commands are executed to execute various operations such as writing, reading and erasing data. Hereinafter, operations of the memory management circuit 702 are described as equivalent to describe operations of the memory control circuit unit 404.

In the present exemplary embodiment, the control commands of the memory management circuit 702 are implemented in a form of a firmware. For instance, the memory management circuit 702 has a microprocessor unit (not illustrated) and a ROM (not illustrated), and the control commands are burned into the ROM. When the memory storage device 10 operates, the control commands are executed by the microprocessor to perform operations of writing, reading or erasing data.

In another exemplary embodiment, the control commands of the memory management circuit 702 may also be stored as program codes in a specific area (for example, the system area in a memory exclusively used for storing system data) of the rewritable non-volatile memory module 406. In addition, the memory management circuit 702 has a microprocessor unit (not illustrated), the read only memory (not illustrated) and a random access memory (not illustrated). More particularly, the ROM has a boot code, which is executed by the microprocessor unit to load the control commands stored in the rewritable non-volatile memory module 406 to the RAM of the memory management circuit 702 when the memory control circuit unit 404 is enabled. Thereafter, the control commands are executed by the microprocessor unit to execute operations of writing, reading or erasing data.

Further, in another exemplary embodiment, the control commands of the memory management circuit 702 may also be implemented in a form of hardware. For example, the memory management circuit 702 includes a microprocessor, a memory cell management circuit, a memory writing circuit, a memory reading circuit, a memory erasing circuit and a data processing circuit. The memory cell management circuit, the memory writing circuit, the memory reading circuit, the memory erasing circuit and the data processing circuit are coupled to the microprocessor. The memory management circuit is configured to manage the physical erasing units of the rewritable non-volatile memory module 406; the memory writing circuit is configured to issue a write command sequence to the rewritable non-volatile memory module 406 in order to write data into the rewritable non-volatile memory module 406; the memory reading circuit is configured to issue a read command sequence to the rewritable non-volatile memory module 406 in order to read data from the rewritable non-volatile memory module 406; the memory erasing circuit is configured to issue an erase command sequence to the rewritable non-volatile memory module 406 in order to erase data from the rewritable non-volatile memory module 406; the data processing circuit is configured to process both the data to be written to the rewritable non-volatile memory module 406 and the data to be read from the rewritable non-volatile memory module 406. Each of the write command sequence, the read command sequence and the erase command sequence may include one or more program codes or command codes, respectively, and instruct the rewritable non-volatile memory module 406 to perform the corresponding operations, such as writing, reading and erasing.

The host interface 704 is coupled to the memory management circuit 702 and configured to receive and identify commands and data sent from the host system 11. In other words, the commands and data sent from the host system 11 are passed to the memory management circuit 702 through the host interface 704. In the present exemplary embodiment, the host interface 704 is compatible with the SATA standard. However, it should be understood that the present disclosure is not limited thereto, and the host interface 704 may also be compatible with a PATA standard, an IEEE 1394 standard, a PCI Express standard, a USB standard, a SD standard, a UHS-I standard, a UHS-II standard, a MS standard, a MMC standard, a eMMC standard, a UFS standard, a CF standard, an IDE standard, or other suitable standards for data transmission.

The memory interface 706 is coupled to the memory management circuit 702 and configured to access the rewritable non-volatile memory module 406. That is, data to be written to the rewritable non-volatile memory module 406 is converted to a format acceptable to the rewritable non-volatile memory module 406 through the memory interface 706. Specifically, if the memory management circuit 702 intends to access the rewritable non-volatile memory module 406, the memory interface 706 sends corresponding command sequences. For example, the command sequences may include the write command sequence which instructs to write data, the read command sequence which instructs to read data, the erase command sequence which instructs to erase data, and other corresponding command sequences configured to instruct performing various memory operations (e.g., for changing read voltage levels or performing a garbage collection procedure). Detailed descriptions regarding the above are omitted herein. These command sequences are generated by the memory management circuit 702 and transmitted to the rewritable non-volatile memory module 406 through the memory interface 706, for example. The command sequences may include one or more signals, or data stored in the bus. The signals or the data may include command codes and programming codes. For example, in a read command sequence, information such as identification codes and memory addresses are included.

The error checking and correcting circuit 708 is coupled to the memory management circuit 702 and configured to execute an error checking and correcting process to ensure the correctness of data. Specifically, when the memory management circuit 702 receives the write command from the host system 11, the error checking and correcting circuit 708 generates an error correcting code (ECC) and/or an error detecting code (EDC) for data corresponding to the write command, and the memory management circuit 702 writes data and the ECC and/or the EDC corresponding to the write command to the rewritable non-volatile memory module 406. Later, when the memory management circuit 702 reads the data from the rewritable non-volatile memory module 406, the corresponding ECC and/or the EDC are also read, and the error checking and correcting circuit 708 executes the error checking and correcting procedure on the read data based on the ECC and/or the EDC.

The buffer memory 710 is coupled to the memory management circuit 702 and configured to temporarily store data and commands from the host system 11 or data from the rewritable non-volatile memory module 406.

In an exemplary embodiment, the memory control circuit unit 404 further includes a power management circuit 712. The power management unit 712 is coupled to the memory management circuit 702 and configured to control a power of the memory storage device 10.

FIG. 8 is a schematic diagram illustrating management of a rewritable non-volatile memory module according to an exemplary embodiment of the disclosure. It should be understood that terms, such as “select”, “group”, “divide”, “associate” and so forth, are logical concepts which describe operations in the physical erasing units of the rewritable non-volatile memory module 406. That is, the physical erasing units of the rewritable non-volatile memory module are logically operated, but actual positions of the physical units of the rewritable non-volatile memory module are not changed.

The memory cells of the rewritable non-volatile memory module 406 constitute a plurality of physical programming units, and the physical programming units constitute a plurality of physical erasing units. Specifically, the memory cells on the same word line constitute one or more of the physical programming units. If each of the memory cells may store more than two bits, the physical programming units on the same word line may be at least classified into a lower physical programming unit and an upper physical programming unit. For instance, a least significant bit (LSB) of one memory cell belongs to the lower physical programming unit, and a most significant bit (MSB) of one memory cell belongs to the upper physical programming unit. Generally, in the MLC NAND flash memory, a writing speed of the lower physical programming unit is higher than a writing speed of the upper physical programming unit, or a reliability of the lower physical programming unit is higher than a reliability of the upper physical programming unit. In the present exemplary embodiment, the physical programming unit is a minimum unit for programming. That is, the programming unit is the minimum unit for writing data. For example, the physical programming unit is a physical page or a physical sector. When the physical programming unit is the physical page, each physical programming unit usually includes a data bit area and a redundancy bit area. The data bit area has multiple physical sectors configured to store user data, and the redundant bit area is configured to store system data (e.g., an error correcting code). In the present exemplary embodiment, the data bit area contains 32 physical sectors, and a size of each physical sector is 512-byte (B). However, in other exemplary embodiments, the data bit area may also include 8, 16 physical sectors or different number (more or less) of the physical sectors, and the size of each physical sector may also be greater or smaller. On the other hand, the physical erasing unit is the minimal unit for erasing. Namely, each physical erasing unit contains the least number of memory cells to be erased together. For instance, the physical erasing unit is a physical block.

Referring to FIG. 8, the memory management circuit 702 may logically divide the physical erasing units 800(0) to 800(R) of the rewritable non-volatile memory module 406 into a plurality of areas such as a storage area 802 and a system area 806.

The physical erasing units in the storage area 802 are configured to store data from the host system 11. The storage area 802 stores valid data and invalid data. For example, when the host system intends to delete one valid data, the data being deleted may still be stored in the storage area 802 but marked as the invalid data. The physical erasing unit not storing the valid data is also known as a spare physical erasing unit. For example, the physical erasing unit being erased may become the spare physical erasing unit. If there are damaged physical erasing units in the storage area 802 or the system area 806, the physical erasing units in the storage area 802 may also be used to replace the damaged physical erasing units. If there are no available physical erasing units in the storage area 802 for replacing the damaged physical erasing units, the memory management circuit 702 may announce that the memory storage device 10 is in a write protect status, so that data may no longer be written thereto. In addition, the physical erasing unit storing the valid data is also known as a non-spare physical erasing unit.

The physical erasing units in the system area 806 are configured to record system information including information related to manufacturer and model of a memory chip, the number of physical erasing units in the memory chip, the number of the physical programming unit in each physical erasing unit, and so forth.

Amounts of the physical erasing units in the storage area 802 and the system area 806 may be different to each other based on the different memory specifications. In addition, it should be understood that, during operations of the memory storage device 10, grouping relations of the physical erasing units associated to the storage area 802 and the system area 806 may be dynamically changed. For example, when damaged physical erasing units in the system area 806 are replaced by the physical erasing units in the storage area 802, the physical erasing units originally from the storage area 802 are then associated to the system area 806.

The memory management circuit 702 configures logical units 810(0) to 810(D) for mapping to the physical erasing units 800(0) to 800(A) in the storage area 802. For example, in the present exemplary embodiment, the host system 11 accesses the data stored in the storage area 802 through logical addresses. Therefore, each of the logical units 810(0) to 810(D) refers to one logical address. In addition, in another exemplary embodiment, each of the logical units 810(0) to 810(D) may also refer to one logical programming unit, one logical erasing unit or a composition of a plurality of consecutive logical addresses. Each of the logical units 810(0) to 810(D) maps to one or more physical units. In the present exemplary embodiment, one physical unit refers to one physical erasing unit. However, in another exemplary embodiment, one physical unit may also be one physical address, one physical programming unit, or a composition of a plurality of consecutive physical addresses, which are not particularly limited in the disclosure.

The memory management circuit 702 records a mapping relation (i.e., logical-to-physical mapping information) between the logical unit and the physical unit into a logical-to-physical mapping table. The logical-to-physical mapping table is stored in the system area 806. When the host system 11 intends to read the data from the memory storage device 10 or write the data into the memory storage device 10, the memory management circuit 702 reads partial information in the logical-to-physical mapping table from the system area 806 into the buffer memory 710, so as to access data in the memory storage device 10.

The memory management circuit 702 looks up or updates partial information in the logical-to-physical mapping table in the buffer memory 710. For example, if the host system 11 instructs to read data stored in one specific logical unit, the memory management circuit 702 may read the logical-to-physical mapping information from the logical-to-physical mapping table in the system area 806 into the buffer memory 710, such that the physical unit storing said data may be obtained and an instruction for reading data from the physical unit may be issued. For example, if the host system 11 instructs to write data into one specific logical unit or delete data stored in the specific logical unit while logical-to-physical mapping information of the logical unit is already temporarily stored in the buffer memory 710 at the time, the memory management circuit 702 may directly update the logical-to-physical mapping information of the logical unit in the buffer memory 710. For example, the memory management circuit 702 may remove the mapping relation of the logical unit or change the logical unit from mapping one specific physical unit to mapping another physical unit. The updated logical-to-physical mapping information of the logical unit may be stored back to the logical-to-physical mapping table stored in the rewritable non-volatile memory module 406 at any time-point.

It is worth mentioning that, if the host system 11 instructs to write data into one specific logical unit or delete data stored in the specific logical unit while the logical-to-physical mapping information of the specific logical unit is not temporarily stored in the buffer memory 710 at the time, the memory management circuit 702 may not instantly read the corresponding logical-to-physical mapping information from the logical-to-physical mapping table in the system area 806 for updating. The reason is that, if the related logical-to-physical mapping information is instantly read into the buffer memory 710 for updating and the updated logical-to-physical mapping information are stored back to the rewritable non-volatile memory module 406 in response to each write command or delete command from the host system 11, the memory cells in the system area 806 may be read or written too frequently to thereby accelerate aging of the memory cells in the system area 806.

Therefore, in the present exemplary embodiment, the memory management circuit 702 establishes a physical-to-logical mapping table in the buffer memory 710. The physical-to-logical mapping table is temporarily stored in the buffer memory 710 and configured to record a mapping relation (i.e., physical-to-logical mapping information), between the physical unit and the logical unit, corresponding to data to be stored by the host system 11). For example, for writing one specific data into one specific physical erasing unit in the storage area 802, the physical-to-logical mapping information corresponding to the data is recorded into the physical-to-logical mapping table in the buffer memory 710 first, and then stored into the last physical programming unit in the physical erasing unit.

In the present exemplary embodiment, the physical-to-logical mapping information stored in a physical erasing unit may serve as a reference for performing specific procedures. For example, the physical-to-logical mapping information stored in one physical erasing unit may include at least one parameter. For example, the parameter may be used to indicate a data volume of valid data (or invalid data) stored in the physical erasing unit (or the number of the physical programming units in which the data needs to be moved) and/or which one of the physical programming unit in the physical erasing unit is stored with valid data (or invalid data) and so on. For example, the parameter may be used in a data merging procedure (e.g., the garbage collection procedure) performed in response to insufficient number of the spare physical erasing units in the rewritable non-volatile memory module 406.

In an exemplary embodiment, according to the physical-to-logical mapping information stored in one specific physical erasing unit, the memory management circuit 702 may obtain a physical-to-logical mapping relation corresponding to one specific data stored in said physical erasing unit. After comparing the physical-to-logical mapping relation with information in the logical-to-physical mapping table, if a comparison result is that a logical unit originally used to store specific data has been changed to mapping another physical unit, it indicates that such data is invalid data. Otherwise, if the comparison result is that the logical unit used to store the data is still mapped to the physical unit currently storing the data, it indicates that such data is valid data.

After a physical-to-logical mapping table in the buffer memory 710 is fully written, the information in the physical-to-logical mapping table is used to update the logical-to-physical mapping table stored in the rewritable non-volatile memory module 406. For example, during the process of writing information into the physical-to-logical mapping table in the buffer memory 710, if the logical-to-physical mapping relation(s) of one or more logical units are changed, the changed logical-to-physical mapping relation(s) may be synchronously updated to the logical-to-physical mapping table stored in the rewritable non-volatile memory module 406 after the physical-to-logical mapping table in the buffer memory 710 is fully written. For example, during the operation of updating the logical-to-physical mapping table stored in the rewritable non-volatile memory module 406 according to the physical-to-logical mapping table in the buffer memory 710, a part of the logical-to-physical mapping information in the logical-to-physical mapping table is read into the buffer memory 710 and updated; and then, the updated logical-to-physical mapping information is re-stored into the rewritable non-volatile memory module 406. By changing multiple logical-to-physical mapping information all at once, a frequency of accessing the rewritable non-volatile memory module 406 may be reduced.

However, in a common recording method of the physical-to-logical mapping table, whether or not the physical-to-logical mapping information of one specific logical unit is repeatedly recorded is not taken into consideration. In other words, even if the host system 11 repeatedly performs data writing operations to the same logical unit, the physical-to-logical mapping relation corresponding to the data writing operation performed each time will all be recorded into the physical-to-logical mapping table one by one. For example, if the physical-to-logical mapping table is fully written by multiple physical-to-logical mapping information of the same logical unit, there may only be one truly useful data (i.e., the last one of physical-to-logical mapping information recorded in the physical-to-logical mapping table) in the subsequent operation of updating the logical-to-physical mapping table. Under such circumstance, a part of spaces in the buffer memory 710 is wasted. Further, the physical-to-logical mapping table may also be fully written easily in such circumstance, such that the logical-to-physical mapping table may be updated more frequently.

In addition, under specific circumstances, if the host system 11 instructs to store specific data into one specific logical unit while the logical-to-physical mapping information of the logical unit is temporarily stored in the buffer memory 710, the logical-to-physical mapping information of the logical unit may be directly updated in the buffer memory 710 and the updated logical-to-physical mapping information of the logical unit may be stored back to the rewritable non-volatile memory module 406 in the subsequent re-storing operation. In other words, in this case, it is not required to update the logical-to-physical mapping table in the rewritable non-volatile memory module 406 according to the physical-to-logical mapping information of the logical unit.

Therefore, in the present exemplary embodiment, after the physical-to-logical mapping information corresponding to at least one write data is stored into one specific physical unit, the physical-to-logical mapping information may be updated in the buffer memory 710, so as to attempt for releasing more available spaces. Hereinafter, for description convenience, the physical-to-logical mapping table is also referred to as a first mapping table, and the logical-to-physical mapping table is also referred to as a second mapping table.

FIG. 9 to FIG. 13 are schematic diagrams illustrating operations of updating the mapping table according to an exemplary embodiment of the disclosure.

Referring to FIG. 9, the memory management circuit 702 receives a write command and write data corresponding to the write command. In the present exemplary embodiment, it is assumed that the write command instructs to write the write data corresponding to the write command into the logical units 810(0) to 810(E). For example, the logical units 810(0) to 810(E) are included in the logical units 810(0) to 810(D) of FIG. 8.

The memory management circuit 702 selects at least one physical erasing unit from the storage area 802 for storing the write data. For example, the memory management circuit 702 selects the physical erasing unit 800(0) for storing the write data. For example, the memory management circuit 702 may send a write command sequence which instructs the rewritable non-volatile memory module 406 to store the write data into physical programming units 910(0) to 910(E) in the physical erasing unit 800(0). Further, the memory management circuit 702 maps the logical units 810(0) to 810(E) to the physical programming units 910(0) to 910(E).

The memory management circuit 702 records physical-to-logical mapping information 922 corresponding to the write data into a first mapping table 920 temporarily stored in the buffer memory 710. For example, the physical-to-logical mapping information 922 includes mapping relations between the physical programming units 910(0) to 910(E) and the logical units 810(0) to 810(E). In other words, the physical-to-logical mapping information 922 includes the physical-to-logical mapping information of each of the logical units 810(0) to 810(E).

According to the first mapping table 920, the memory management circuit 702 sends another write command sequence which instructs to store the physical-to-logical mapping information 922 into a physical programming unit 910(F). For example, the physical programming unit 910(F) is the last physical programming unit arranged in the physical erasing unit 800(0). For example, the memory management circuit 702 instructs to store the write data into the physical programming units 910(0) to 910(E) first, and then store the physical-to-logical mapping information 922 corresponding to the write data into the physical programming unit 910(F). Further, in another exemplary embodiment, the physical erasing unit 800(0) may also be any one physical unit storing at least partial data of the write data in the rewritable non-volatile memory module 406.

After storing the physical-to-logical mapping information 922 into the physical programming unit 910(F), the memory management circuit 702 updates the physical-to-logical mapping information 922 recorded in the first mapping table 920 in the buffer memory 710, so as to attempt for reducing a data size of the physical-to-logical mapping information 922.

In the present exemplary embodiment, the buffer memory 710 is temporarily stored with a second mapping table 930. The second mapping table 930 includes at least partial information read from the logical-to-physical mapping table stored in the rewritable non-volatile memory module 406. For example, the second mapping table 930 includes logical-to-physical mapping information 932.

In the present exemplary embodiment, the memory management circuit 702 compares the physical-to-logical mapping information 922 with the logical-to-physical mapping information 932 and determines whether mapping information related to the same logical unit exists therein. If the mapping information related to the same logical unit is included by both the physical-to-logical mapping information 922 and the logical-to-physical mapping information 932, the memory management circuit 702 removes the physical-to-logical mapping information of such logical unit from the physical-to-logical mapping information 922. For example, in an exemplary embodiment, if the logical-to-physical mapping information 932 includes the logical-to-physical mapping information of the logical unit 810(0), the memory management circuit 702 removes the physical-to-logical mapping information of the logical unit 810(0) (i.e., the physical-to-logical mapping information corresponding to the write data stored in the logical unit 810(0)) from the physical-to-logical mapping information 922 and keeps the physical-to-logical mapping information of the logical units 810(1) to 810(E) (i.e., the physical-to-logical mapping information corresponding to the write data stored in the logical units 810(1) to 810(E)) in the physical-to-logical mapping information 922.

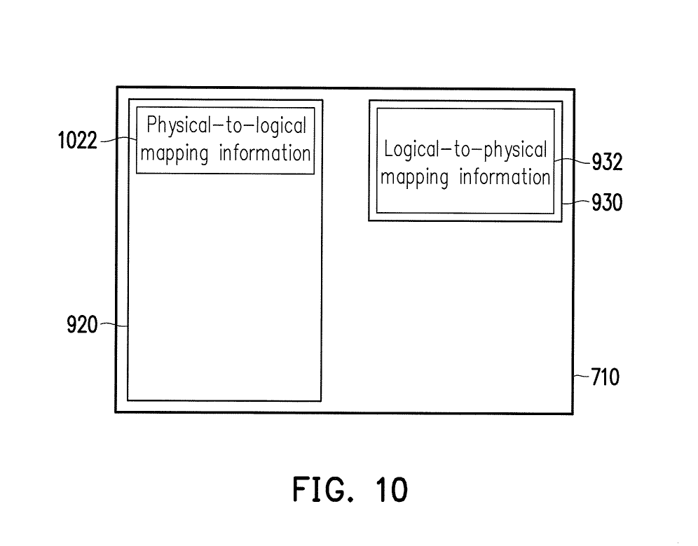

Referring to FIG. 10, it is assumed that the physical-to-logical mapping information 922 is updated to physical-to-logical mapping info nation 1022. For example, the physical-to-logical mapping information 1022 only includes the physical-to-logical mapping information of the logical units 810(1) to 810(E). In the present exemplary embodiment, because the physical-to-logical mapping information 1022 only includes partial information of the physical-to-logical mapping information 922, a data size of the physical-to-logical mapping information 1022 is less than the data size of the physical-to-logical mapping information 922.

However, in another exemplary embodiment, if the mapping information related to the same logical unit is not included by both the physical-to-logical mapping information 922 and the logical-to-physical mapping information 932 (e.g., the logical-to-physical mapping information 932 does not include the logical-to-physical mapping information of any one of logical units 810(0) to 810(E)), the data size of the physical-to-logical mapping information 1022 may be identical to the data size of the physical-to-logical mapping information 922.

According to another exemplary embodiment of FIG. 9, in the operation of updating the physical-to-logical mapping information 922, the memory management circuit 702 further determines whether multiple physical-to-logical mapping information recorded in the first mapping table 920 belongs to the same logical unit. Among the multiple physical-to-logical mapping information of the same logical unit, the memory management circuit 702 keeps the last physical-to-logical mapping information, whereas the rest of the physical-to-logical mapping information of the same logical unit are removed from the first mapping table 920. For example, if the host system 11 repeatedly performs N times of writing operations on the logical unit 810(0), the physical-to-logical mapping information 922 may include an N number of the physical-to-logical mapping information of the logical unit 810(0). Since only the last physical-to-logical mapping information of the logical unit 810(0) may reflect a final physical-to-logical mapping relation of the logical unit 810(0) during the N times of writing operations, the physical-to-logical mapping information 1022 includes N^{th} physical-to-logical mapping information of the logical unit 810(0) without including the previous N−1 number of the physical-to-logical mapping information of the logical unit 810(0).

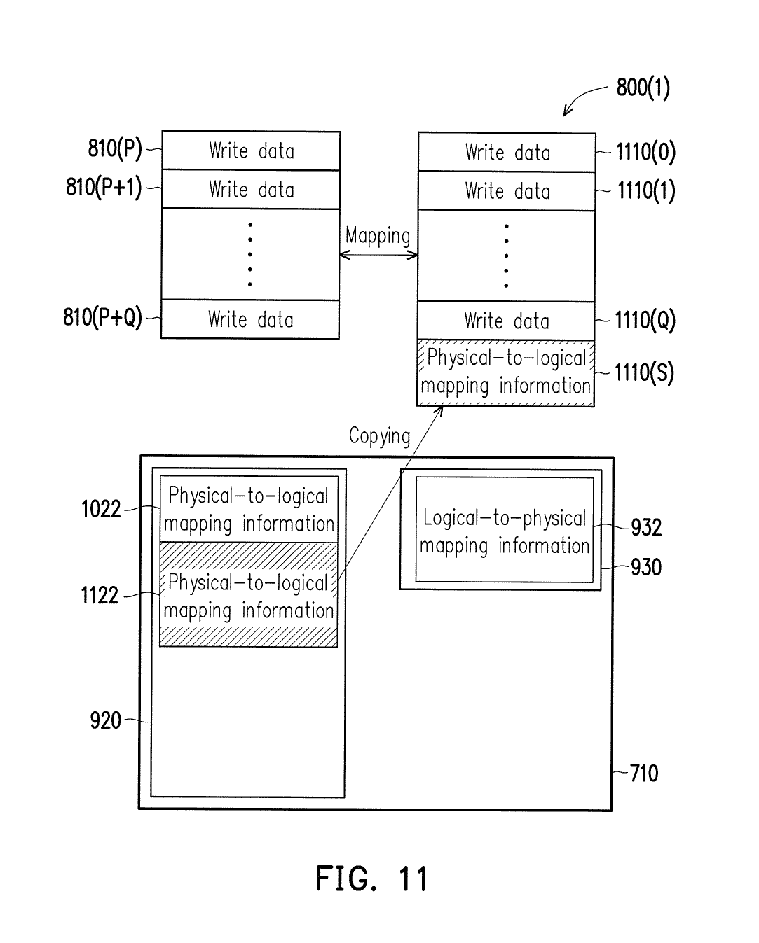

Referring to FIG. 11, the memory management circuit 702 receives another write command and write data corresponding to such write command. In the present exemplary embodiment, it is assumed that the write command instructs to write the write data corresponding to the write command into logical units 810(P) to 810(P+Q). For example, the logical units 810(P) to 810(P+Q) are also included in the logical units 810(0) to 810(D) of FIG. 8.

The memory management circuit 702 selects at least one physical erasing unit from the storage area 802 for storing the write data. For example, the memory management circuit 702 selects the physical erasing unit 800(1) for storing the write data. For example, the memory management circuit 702 sends a write command sequence which instructs the rewritable non-volatile memory module 406 to store the write data into physical programming units 1110(1) to 1110(Q) in the physical erasing unit 800(1). Further, the memory management circuit 702 maps the logical units 810(P) to 810(P+Q) to the physical programming units 1110(0) to 1110(Q).

The memory management circuit 702 records physical-to-logical mapping information 1122 corresponding to the write data into the first mapping table 920 temporarily stored in the buffer memory 710 in continuation to the physical-to-logical mapping information 1022. For example, the physical-to-logical mapping information 1122 includes mapping relations between the physical programming units 1110(0) to 1110(Q) and the logical units 810(P) to 810(Q+P). For example, the physical-to-logical mapping information 1122 includes the physical-to-logical mapping information of each of the logical units 810(P) to 810(P+Q).

According to the first mapping table 920, the memory management circuit 702 sends another write command sequence which instructs to store the physical-to-logical mapping information 1122 into a physical programming unit 1110(S). For example, the physical programming unit 1110(S) is the last one of physical programming unit in the physical erasing unit 800(1).

After storing the physical-to-logical mapping information 1122 into the physical programming unit 1110(S), the memory management circuit 702 updates the physical-to-logical mapping information 1122 recorded in the first mapping table 920 in the buffer memory 710, so as to attempt for reducing a data size of the physical-to-logical mapping information 1122. For example, the memory management circuit 702 may compare the physical-to-logical mapping information 1122 with the logical-to-physical mapping information 932 and determine whether mapping information related to the same logical unit exists therein. If the mapping information related to the same logical unit is included by both the physical-to-logical mapping information 1122 and the logical-to-physical mapping information 932, the memory management circuit 702 removes the physical-to-logical mapping information of such logical unit from the physical-to-logical mapping information 1122 in order to update the physical-to-logical mapping information 1122. Further, the memory management circuit 702 may determine whether the first mapping table 920 includes multiple physical-to-logical mapping information of the same logical unit and remove a part of the physical-to-logical mapping information of the same logical unit from the first mapping table 920. For example, if two physical-to-logical mapping information of the logical unit 810(P) exist in the physical-to-logical mapping information 1122 at the same time, the physical-to-logical mapping information of the logical unit 810(P) recorded earlier in time is removed, whereas the physical-to-logical mapping information of the logical unit 810(P) recorded later in time is kept.

In an exemplary embodiment, the physical-to-logical mapping information 1022 and 1122 may be synchronously updated. For example, if two physical-to-logical mapping information of the logical unit 810(P) exist separately in the physical-to-logical mapping information 1022 and the physical-to-logical mapping information 1122, the physical-to-logical mapping information of the logical unit 810(P) existed in the physical-to-logical mapping information 1022 recorded earlier in time may be removed.

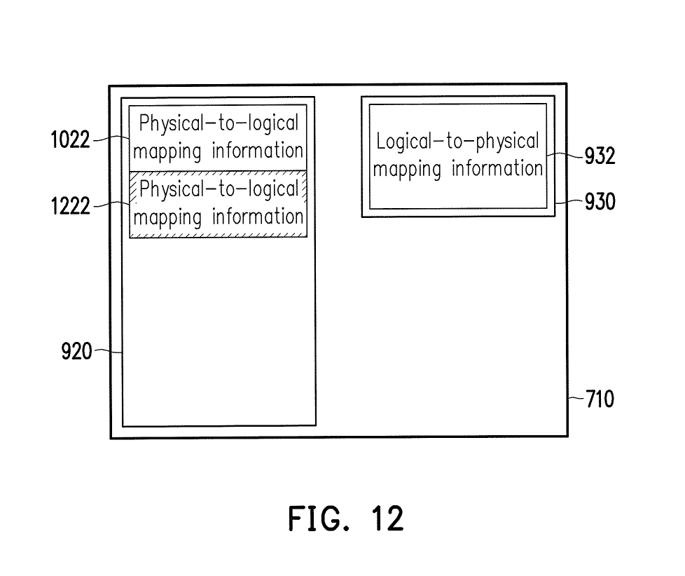

Referring to FIG. 12, after the physical-to-logical mapping information 1122 is updated to physical-to-logical mapping information 1222, if the physical-to-logical mapping information 1222 only includes partial info nation of the physical-to-logical mapping information 1122, a data size of the physical-to-logical mapping information 1222 is less than the data size of the physical-to-logical mapping information 1122.

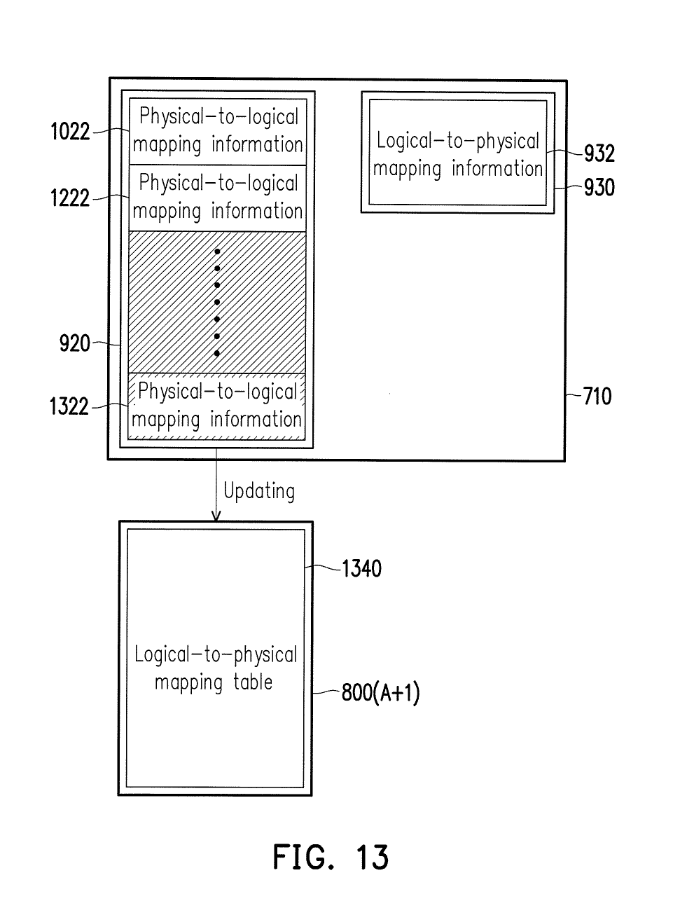

Referring to FIG. 13, the memory management circuit 702 may receive more write commands and correspondingly records more physical-to-logical mapping information into the first mapping table 920. The physical-to-logical mapping information recorded in the first mapping table 920 is copied into the corresponding physical unit and then updated. As shown in FIG. 13, physical-to-logical mapping information 1322 is the last updated physical-to-logical mapping information in the first mapping table 920.

In the present exemplary embodiment of FIG. 13, the first mapping table 920 does not include multiple physical-to-logical mapping information of the same logical unit. However, in another exemplary embodiment, the physical-to-logical mapping information generated by one (or the same) updating procedure does not include multiple physical-to-logical mapping information of the same logical unit, but the physical-to-logical mapping information generated by multiple (or different) updating procedures may include multiple physical-to-logical mapping information of the same logical unit. For example, each of the physical-to-logical mapping information 1022 and 1322 may include one physical-to-logical mapping information of the logical unit 810(0).

After recording the updated physical-to-logical mapping information 1322 into the first mapping table 920, the memory management circuit 702 updates a second mapping table 1340 stored in the system area 806 according to the updated physical-to-logical mapping information recorded in the first mapping table 920. For example, the second mapping table 1340 is a logical-to-physical mapping table stored in the physical erasing unit 800(A+1). Methods regarding how to update the second mapping table according to the first mapping table have been described as the above, which are not repeated hereinafter.

In particular, in the exemplary embodiment of FIG. 13, because information in the first mapping table 920 is filtered information, in comparison to a general recording method for the physical-to-logical mapping table, the first mapping table 920 may store more of valid (or useful) physical-to-logical mapping information. Later, when the second mapping table 1340 is updated according to the first mapping table 920, wastes of system source and time may also be reduced accordingly.

It is worth mentioning that, in the exemplary embodiments of FIG. 9 to FIG. 13, the original physical-to-logical mapping information is directly overwritten by the updated physical-to-logical mapping information in the first mapping table 920. However, in another exemplary embodiment, a reserved area may also be configured in the first mapping table, and the physical-to-logical mapping information that is not yet updated may be recorded in continuation to the reserved area. As such, after updating aforesaid physical-to-logical mapping information, the physical-to-logical mapping information originally recorded in continuation to the reserved area may be removed, and the updated physical-to-logical mapping information may be recorded into the reserved area.

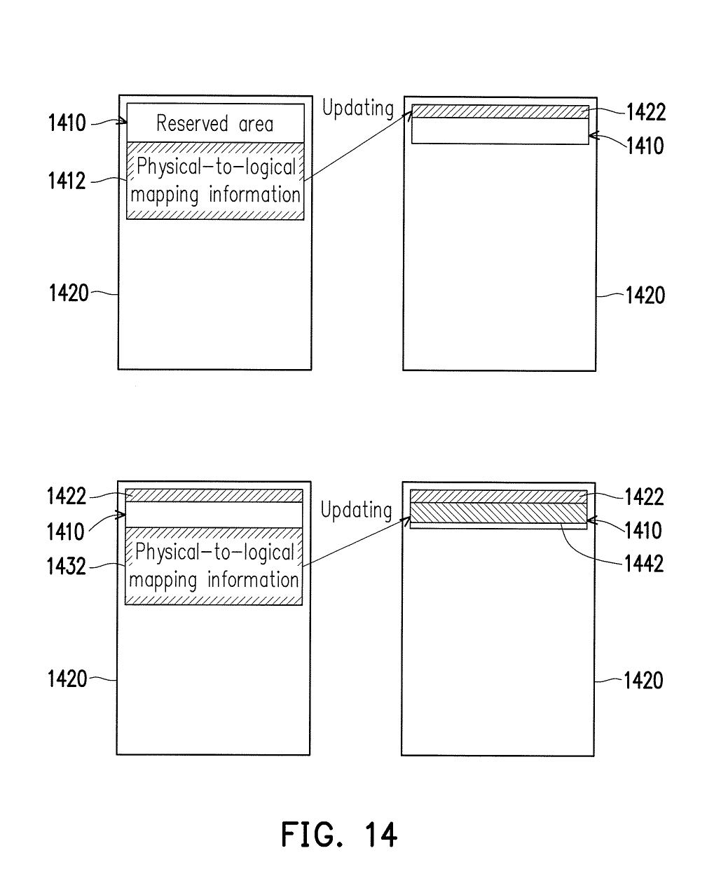

FIG. 14 is a schematic diagram illustrating use of the reserved area for updating the first mapping table according to an exemplary embodiment of the disclosure.

Referring to FIG. 14, in the present exemplary embodiment, a reserved area (also known as a first area) 1410 is configured in a first mapping table 1420. Physical-to-logical mapping information 1412 corresponding to specific write data is recorded in another area (also known as a second area) in continuation to the reserved area 1410. After updating the physical-to-logical mapping information 1412 into physical-to-logical mapping information 1422, the physical-to-logical mapping information 1412 is removed from the first mapping table 1420 and the physical-to-logical mapping information 1422 is recorded into the reserved area 1410. Later, if another write command and the corresponding write data are received, physical-to-logical mapping information 1432 corresponding to the write data is recorded into the area in continuation to the reserved area 1410. After updating the physical-to-logical mapping information 1432 to physical-to-logical mapping information 1442, the physical-to-logical mapping information 1432 is removed from the first mapping table 1420 and the physical-to-logical mapping information 1442 is recorded into the reserved area 1410. By analogy, more of the physical-to-logical mapping information may be organized in the first mapping table 1420 according to aforesaid rule. In particular, if the reserved area 1410 is almost or already fully written, before recording the next physical-to-logical mapping information into the first mapping table 1420, one new reserved area (not illustrated) may be configured in order to store the next updated physical-to-logical mapping information.

In an exemplary embodiment, before updating specific physical-to-logical mapping information recorded in the first mapping table, the memory management circuit 702 further estimates a data size of the updated physical-to-logical mapping information and determines whether the estimated data size is greater than a preset size. The memory management circuit 702 actually updates the physical-to-logical mapping information only when the estimated data size is not greater than the preset size. In other words, if the estimated data size of the updated physical-to-logical mapping information is greater than the preset size, it indicates that updating of the data may not save many spaces, such that the memory management circuit 702 skips updating of such physical-to-logical mapping information. For example, the preset size may be set in correspondence to a data size of physical-to-logical mapping information pending for updating. For example, the preset size may be set to a preset percentage (e.g., 50%) of the data size of the physical-to-logical mapping information pending for updating. Alternatively, according to the exemplary embodiment of FIG. 14, the preset size may also be set as equal to a size (or a rest size) of the reserved area 1410.

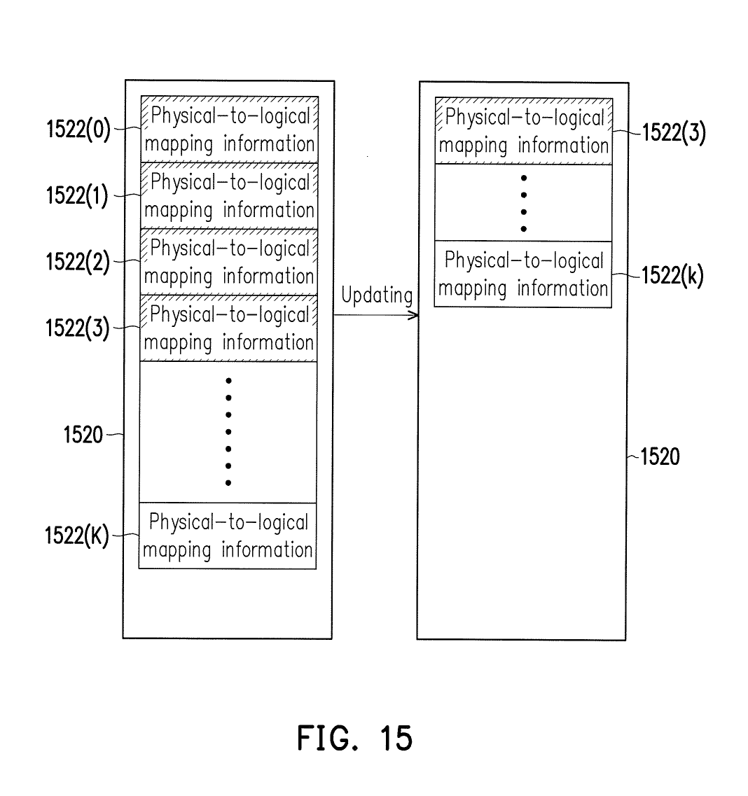

FIG. 15 is a schematic diagram illustrating an operation of removing the physical-to-logical mapping information in order to update the first mapping table according to an exemplary embodiment of the disclosure.

Referring to FIG. 15, physical-to-logical mapping information 1522(0) to 1522(K) are recorded into a first mapping table 1520 temporarily stored in the buffer memory in response to one specific write data. After the physical-to-logical mapping information 1522(0) to 1522(K) are copied and stored into a specific physical unit in the rewritable non-volatile memory module, the physical-to-logical mapping information 1522(0) to 1522(K) are updated in the first mapping table 1520. In the present exemplary embodiment, the memory management circuit 702 determines whether the physical-to-logical mapping information 1522(0) to 1522(K) include multiple physical-to-logical mapping information of the same logical unit. Assuming that the physical-to-logical mapping information 1522(0) to 1522(3) belong to the same logical unit, in the corresponding mapping table updating operation, the memory management circuit 702 removes the physical-to-logical mapping information 1522(0) to 1522(2) that is recorded earlier among the physical-to-logical mapping information 1522(0) to 1522(3) and keeps the physical-to-logical mapping information 1522(3) that is recorded latest among the physical-to-logical mapping information 1522(0) to 1522(3).

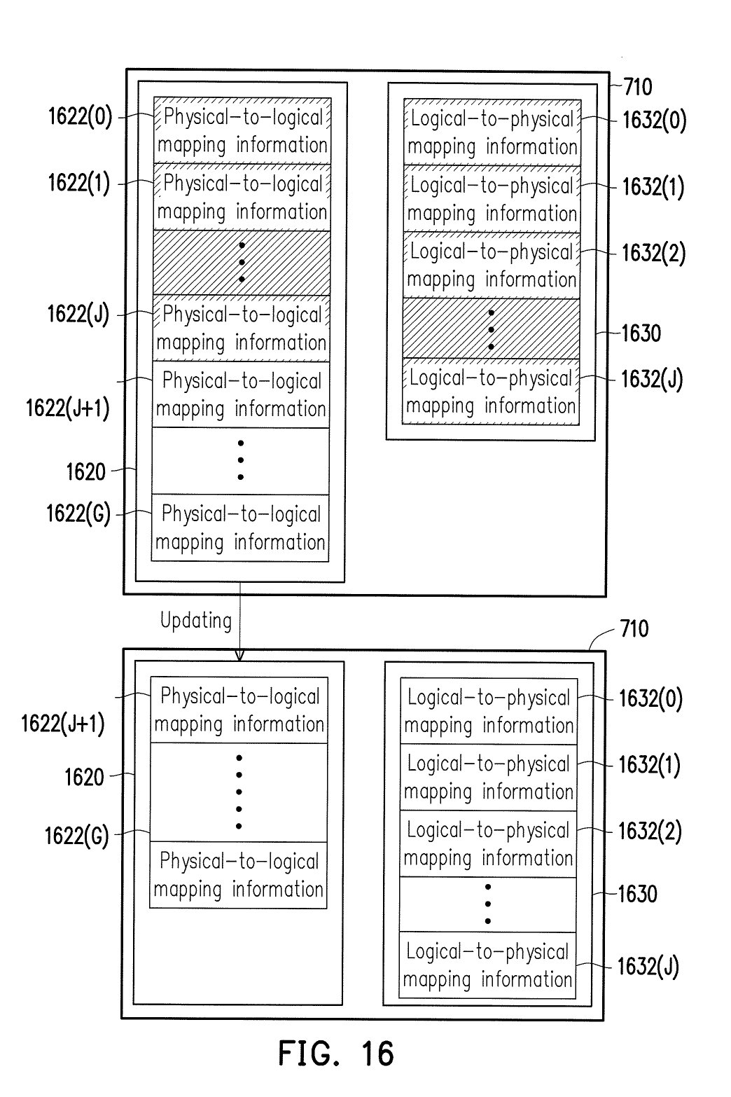

FIG. 16 is a schematic diagram illustrating an operation of removing the physical-to-logical mapping information in order to update the first mapping table according to another exemplary embodiment of the disclosure.

Referring to FIG. 16, physical-to-logical mapping information 1622(0) to 1622(G) are recorded into a first mapping table 1620 temporarily stored in the buffer memory 710 in response to one specific write data. In particular, while recording the physical-to-logical mapping information 1622(0) to 1622(G) into the first mapping table 1620 temporarily stored in the buffer memory 710, the buffer memory 710 is also temporarily stored with a second mapping table 1630. For example, the second mapping table 1630 is recorded with logical-to-physical mapping information 1632(0) to 1632(J).

After the physical-to-logical mapping information 1622(0) to 1622(G) are copied and stored into one specific physical unit in the rewritable non-volatile memory module, the physical-to-logical mapping information 1622(0) to 1622(G) are updated in the first mapping table 1620. In the present exemplary embodiment, the memory management circuit 702 compares the physical-to-logical mapping information 1622(0) to 1622(G) with the logical-to-physical mapping information 1632(0) to 1632(J) and determines whether mapping information related to the same logical unit exists therein. In the present exemplary embodiment, if the physical-to-logical mapping information 1622(0) to 1622(J) belong to at least one specific logical unit and the physical-to-logical mapping information of the at least one specific logical unit is included in the logical-to-physical mapping information 1632(0) to 1632(J), in the corresponding table updating operation, the memory management circuit 702 removes the physical-to-logical mapping information 1622(0) to 1622(J) from the first mapping table 1620 and keeps the physical-to-logical mapping information 1622(J+1) to 1622(G) in the first mapping table 1620. Accordingly, after the first mapping table 120 temporarily stored in the buffer memory 710 is updated, none of logical-to-physical mapping information of the logical unit in the kept physical-to-logical mapping information 1622(J+1) to 1622(G) is included in the logical-to-physical mapping information 1632(0) to 1632(J) temporarily stored in the buffer memory 710 at the same time.

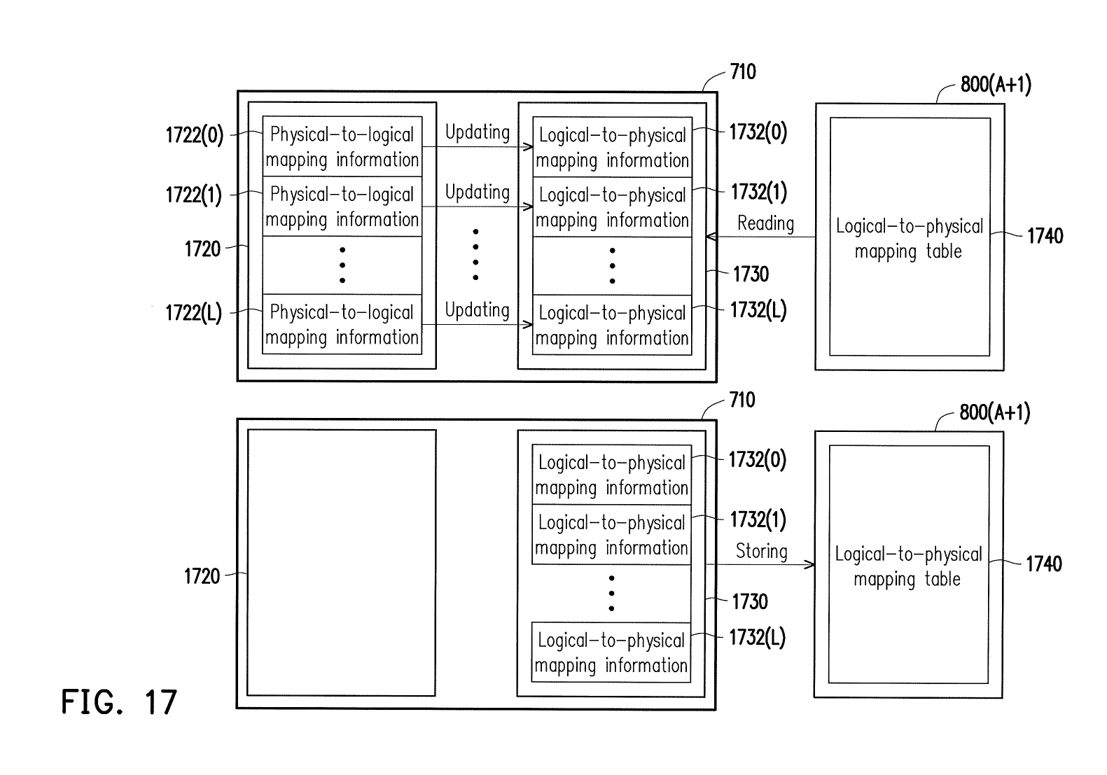

FIG. 17 is a schematic diagram illustrating an operation of updating the second mapping table according to an exemplary embodiment of the disclosure.

Referring to FIG. 17, if a first mapping table 1720 temporarily stored in the buffer memory 710 is fully written by physical-to-logical mapping information 1722(0) to 1722(L), partial information in the logical-to-physical mapping table 1740 (i.e., the second mapping table) stored in the physical erasing unit 800(A+1) of the rewritable non-volatile memory module is read into the buffer memory 710. For example, the information read into the buffer memory 710 is regarded as a second mapping table 1730 which includes logical-to-physical mapping information 1732(0) to 1732(L). Each of information in the logical-to-physical mapping information 1732(0) to 1732(L) is corresponding to one specific information in the physical-to-logical mapping information 1722(0) to 1722(L). For example, the logical-to-physical mapping information 1732(0) is corresponding to the physical-to-logical mapping information 1722(0), the logical-to-physical mapping information 1732(1) is corresponding to the physical-to-logical mapping information 1722(1), and the rest may be deduced by analogy. The physical-to-logical mapping information 1722(0) to 1722(L) are used to update the logical-to-physical mapping information 1732(0) to 1732(L) temporarily stored in the buffer memory 710 at the same time. For example, the logical-to-physical mapping information 1732(0) records an old logical-to-physical mapping relation of one specific logical unit and the physical-to-logical mapping information 1722(0) records a new physical-to-logical mapping relation of the specific logical unit, such that the new physical-to-logical mapping relation may be used to update the old logical-to-physical mapping relation. After the logical-to-physical mapping information 1732(0) to 1732(L) are updated, the updated physical-to-logical mapping information 1732(0) to 1732(L) are stored back to the rewritable non-volatile memory module (e.g., into the logical-to-physical mapping table 1740). Further, information in the first mapping table 1720 may be removed so that physical-to-logical mapping information of the next write data from the host system may be temporarily stored.

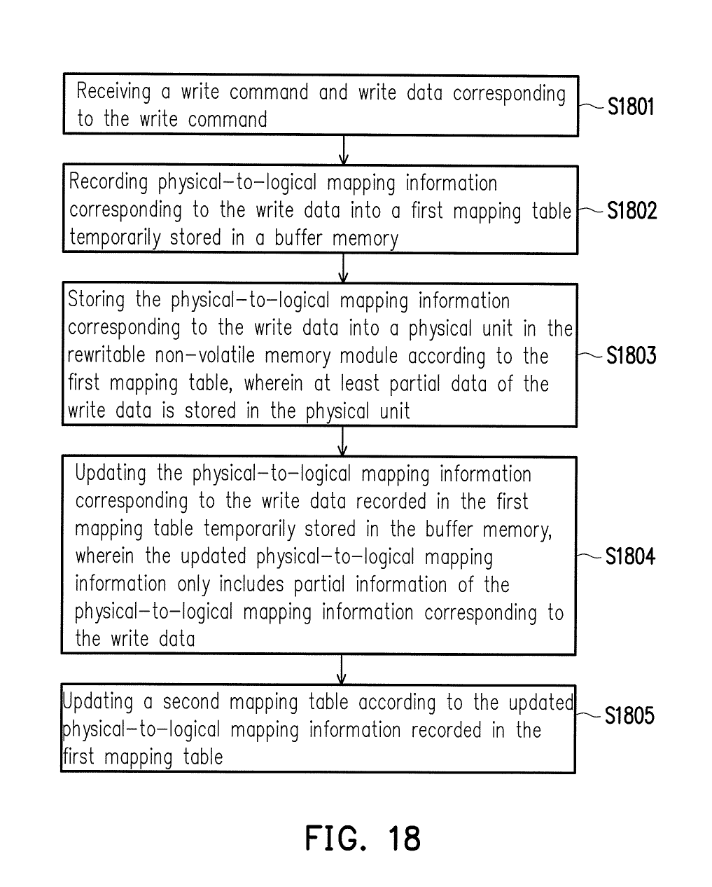

FIG. 18 is a flowchart illustrating a mapping table updating method according to an exemplary embodiment of the disclosure.

Referring to FIG. 18, in step S1801, a write command and write data corresponding to the write command are received. In step S1802, physical-to-logical mapping information corresponding to the write data is recorded into a first mapping table temporarily stored in a buffer memory. In step S1803, the physical-to-logical mapping information corresponding to the write data is stored into a physical unit in the rewritable non-volatile memory module according to the first mapping table, wherein the physical unit is stored with at least partial data of the write data. In step S1804, the physical-to-logical mapping information corresponding to the write data recorded in the first mapping table temporarily stored in the buffer memory is updated, wherein the updated physical-to-logical mapping information only includes partial information of the physical-to-logical mapping information corresponding to the write data. In step S1805, a second mapping table is updated according to the updated physical-to-logical mapping information recorded in the first mapping table.

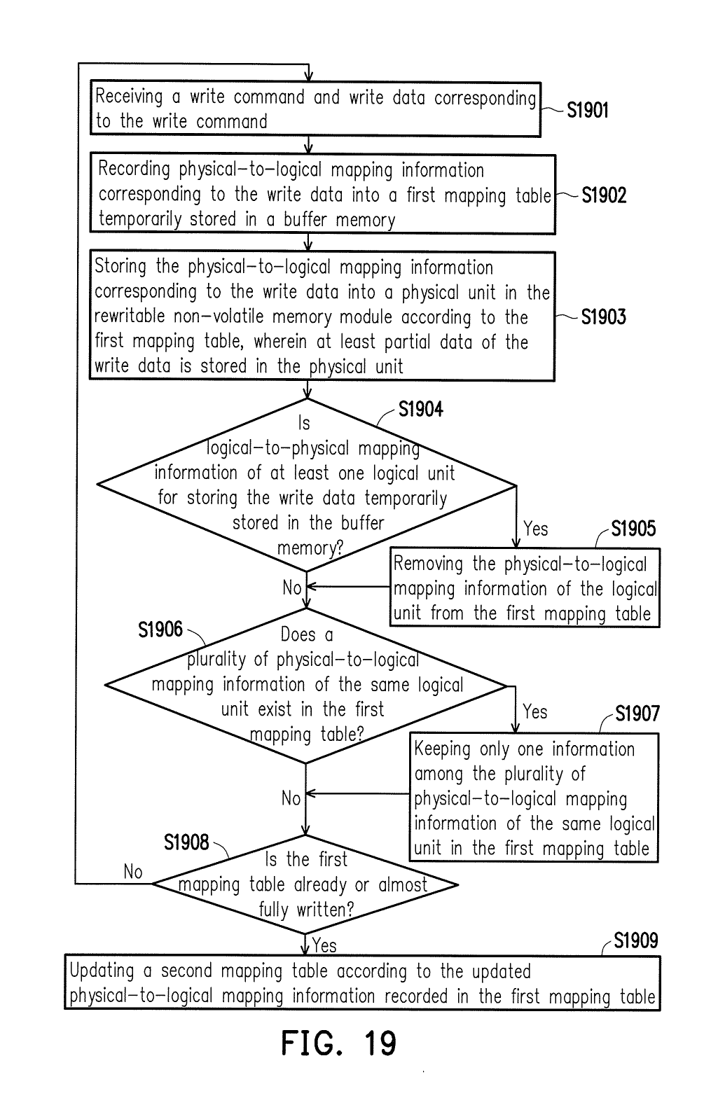

FIG. 19 is a flowchart illustrating a mapping table updating method according to another exemplary embodiment of the disclosure.

Referring to FIG. 19, in step S1901, a write command and write data corresponding to the write command are received. In step S1902, physical-to-logical mapping information corresponding to the write data is recorded into a first mapping table temporarily stored in a buffer memory. In step S1903, the physical-to-logical mapping information corresponding to the write data is stored into a physical unit in the rewritable non-volatile memory module according to the first mapping table, wherein the physical unit is stored with at least partial data of the write data. In step S1904, whether logical-to-physical mapping information of at least one logical unit for storing the write data is temporarily stored in the buffer memory is determined. If a determination result of step S1904 is yes, the physical-to-logical mapping information of such logical unit is removed from the first mapping table in step S1905. If the determination result of step S1904 is no, whether multiple physical-to-logical mapping information of one same logical unit exists in the first mapping table is determined in step S1906. If a determination result of step S1906 is yes, only one information among the multiple physical-to-logical mapping information of the same logical unit in the first mapping table is kept. If the determination result of step S1906 is no, whether the first mapping table is already or almost fully written is determined in step S1908. If the first mapping table is already or almost fully written, in step S1909, a second mapping table is updated according to the updated physical-to-logical mapping information recorded in the first mapping table. If the first mapping table is not fully written or still has sufficient spaces, step S1901 may be repeatedly performed after the step S1908, so as to continue using the first mapping table.

In the present exemplary embodiment, step S1904 to step S1907 are operations for updating the first mapping table temporarily stored in the buffer memory. However, in another exemplary embodiment, it may selectively perform only step S1904 and step S1905 or perform only step S1906 and step S1907 in the updating operation for the first mapping table.

In another exemplary embodiment, step S1908 further includes determining whether the memory storage device or the memory control circuit unit is in a specific state or whether a reorganize command is received. For example, the specific state may be an idle state, a state indicating that the power is just turned on, or a state indicating that the power is about to be turned off If the memory storage device or the memory control circuit unit is in said specific state or the reorganize command is received, step S1909 will be performed. If the memory storage device or the memory control circuit unit is not in the specific state, the reorganize command is not received and the first mapping table is not fully written, step S1901 may be repeatedly performed.

Nevertheless, each of steps depicted in FIG. 18 and FIG. 19 have been described in detail as above, thus related description thereof is not repeated hereinafter. It should be noted that, the steps depicted in FIG. 18 and FIG. 19 may be implemented as a plurality of program codes or circuits, which are not particularly limited in the disclosure. Moreover, the methods disclosed in FIG. 18 and FIG. 19 may be implemented with reference to above embodiments, or may be implemented separately, which are not particularly limited in the disclosure.

In summary, after storing the physical-to-logical mapping information of one specific write data from the buffer memory into the rewritable non-volatile memory module, the physical-to-logical mapping information of the specific write data is updated in the buffer memory so as to attempt for releasing more available spaces in the buffer memory. Accordingly, in an exemplary embodiment, the situation where the physical-to-logical mapping table in the rewritable non-volatile memory module is updated too frequently because the physical-to-logical mapping table in the buffer memory is easily fully written may be prevented.

It will be apparent to those skilled in the art that various modifications and variations may be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A mapping table updating method for a rewritable non-volatile memory module, and the mapping table updating method comprising:
receiving a write command and write data corresponding to the write command;
recording physical-to-logical mapping information corresponding to the write data into a first mapping table temporarily stored in a buffer memory;
storing the physical-to-logical mapping information corresponding to the write data into a physical unit in the rewritable non-volatile memory module according to the first mapping table, wherein the physical unit is stored with at least partial data of the write data;
updating the physical-to-logical mapping information corresponding to the write data recorded in the first mapping table temporarily stored in the buffer memory, wherein the updated physical-to-logical mapping information only comprises partial information of the physical-to-logical mapping information corresponding to the write data; and
updating a second mapping table according to the updated physical-to-logical mapping information recorded in the first mapping table.

2. The mapping table updating method of claim 1, wherein the step of recording the physical-to-logical mapping information corresponding to the write data into the first mapping table comprises:
reserving a first area in the first mapping table; and
recording the physical-to-logical mapping information corresponding to the write data into a second area in the first mapping table.

3. The mapping table updating method of claim 2, wherein the step of updating the physical-to-logical mapping information corresponding to the write data recorded in the first mapping table temporarily stored in the buffer memory comprises:
removing the physical-to-logical mapping information corresponding to the write data recorded in the second area; and
recording the updated physical-to-logical mapping information into the first area.

4. The mapping table updating method of claim 1, wherein the write data comprises first write data and second write data,
wherein the step of updating the physical-to-logical mapping information corresponding to the write data recorded in the first mapping table temporarily stored in the buffer memory comprises:
keeping the physical-to-logical mapping information corresponding to the first write data in the first mapping table; and
removing the physical-to-logical mapping information corresponding to the second write data from the first mapping table.

5. The mapping table updating method of claim 4, wherein logical-to-physical mapping information of a logical unit for storing the second write data is temporarily stored in the buffer memory when the write command is received.

6. The mapping table updating method of claim 1, wherein the first mapping table is a physical-to-logical mapping table, wherein the second mapping table is a logical-to-physical mapping table.

7. The mapping table updating method of claim 1, wherein the step of updating the physical-to-logical mapping information corresponding to the write data recorded in the first mapping table temporarily stored in the buffer memory is performed only when a data size of the updated physical-to-logical mapping information is not greater than a preset size.

8. The mapping table updating method of claim 1, wherein the step of updating the physical-to-logical mapping information corresponding to the write data recorded in the first mapping table temporarily stored in the buffer memory comprises:
determining whether logical-to-physical mapping information of at least one logical unit for storing the write data is temporarily stored in the buffer memory;
if the logical-to-physical mapping information of a logical unit for storing a first write data in the write data is not temporarily stored in the buffer memory, keeping the physical-to-logical mapping information corresponding to the first write data in the first mapping table; and
if the logical-to-physical mapping information of a logical unit for storing a second write data in the write data is temporarily stored in the buffer memory, removing the physical-to-logical mapping information corresponding to the second write data from the first mapping table.

9. The mapping table updating method of claim 1, wherein the step of updating the physical-to-logical mapping information corresponding to the write data recorded in the first mapping table temporarily stored in the buffer memory comprises:
determining whether multiple physical-to-logical mapping information of a same logical unit exists in the first mapping table temporarily stored in the buffer memory; and
if the multiple physical-to-logical mapping information of the same logical unit exists in the first mapping table temporarily stored in the buffer memory, keeping only one of the multiple physical-to-logical mapping information of the same logical unit in the first mapping table.

10. A memory storage device, comprising:
a connection interface unit, configured to couple to a host system;
a rewritable non-volatile memory module; and
a memory control circuit unit, coupled to the connection interface unit and the rewritable non-volatile memory module,
wherein the memory control circuit unit is configured to receive a write command and write data corresponding to the write command,
wherein the memory control circuit unit is further configured to record physical-to-logical mapping information corresponding to the write data into a first mapping table temporarily stored in a buffer memory,
wherein the memory control circuit unit is further configured to send a write command sequence according to the first mapping table temporarily stored in the buffer memory to instruct for storing the physical-to-logical mapping information corresponding to the write data into a physical unit in the rewritable non-volatile memory module, wherein the physical unit is stored with at least partial data of the write data,
wherein the memory control circuit unit is further configured to update the physical-to-logical mapping information corresponding to the write data recorded in the first mapping table temporarily stored in the buffer memory, wherein the updated physical-to-logical mapping information only comprises partial information of the physical-to-logical mapping information corresponding to the write data,
wherein the memory control circuit unit is further configured to update a second mapping table according to the updated physical-to-logical mapping information recorded in the first mapping table.

11. The memory storage device of claim 10, wherein the operation of recording the physical-to-logical mapping information corresponding to the write data into the first mapping table by the memory control circuit unit comprises:
reserving a first area in the first mapping table; and
recording the physical-to-logical mapping information corresponding to the write data into a second area in the first mapping table.

12. The memory storage device of claim 11, wherein the operation of updating the physical-to-logical mapping information corresponding to the write data recorded in the first mapping table temporarily stored in the buffer memory by the memory control circuit unit comprises:
removing the physical-to-logical mapping information corresponding to the write data recorded in the second area; and
recording the updated physical-to-logical mapping information into the first area.

13. The memory storage device of claim 10, wherein the write data comprises first write data and second write data,
wherein the operation of updating the physical-to-logical mapping information corresponding to the write data recorded in the first mapping table temporarily stored in the buffer memory by the memory control circuit unit comprises:
keeping the physical-to-logical mapping information corresponding to the first write data in the first mapping table; and
removing the physical-to-logical mapping information corresponding to the second write data from the first mapping table.

14. The memory storage device of claim 13, wherein logical-to-physical mapping information of a logical unit for storing the second write data is temporarily stored in the buffer memory when the write command is received.

15. The memory storage device of claim 10, wherein the first mapping table is a physical-to-logical mapping table, wherein the second mapping table is a logical-to-physical mapping table.

16. The memory storage device of claim 10, wherein the operation of updating the physical-to-logical mapping information corresponding to the write data recorded in the first mapping table temporarily stored in the buffer memory is performed only when a data size of the updated physical-to-logical mapping information is not greater than a preset size.

17. The memory storage device of claim 10, wherein the operation of updating the physical-to-logical mapping information corresponding to the write data recorded in the first mapping table temporarily stored in the buffer memory by the memory control circuit unit comprises:
determining whether logical-to-physical mapping information of at least one logical unit for storing the write data is temporarily stored in the buffer memory;
if the logical-to-physical mapping information of a logical unit for storing a first write data in the write data is not temporarily stored in the buffer memory, keeping the physical-to-logical mapping information corresponding to the first write data in the first mapping table; and
if the logical-to-physical mapping information of a logical unit for storing a second write data in the write data is temporarily stored in the buffer memory, removing the physical-to-logical mapping information corresponding to the second write data from the first mapping table.

18. The memory storage device of claim 10, wherein the operation of updating the physical-to-logical mapping information corresponding to the write data recorded in the first mapping table temporarily stored in the buffer memory by the memory control circuit unit comprises:
determining whether multiple physical-to-logical mapping information of a same logical unit exists in the first mapping table temporarily stored in the buffer memory; and
if the multiple physical-to-logical mapping information of the same logical unit exists in the first mapping table temporarily stored in the buffer memory, keeping only one of the multiple physical-to-logical mapping information of the same logical unit in the first mapping table.

19. A memory control circuit unit, configured to control a rewritable non-volatile memory module, and the memory control circuit unit comprising:
a host interface, configured to couple to a host system;
a memory interface, configured to couple to the rewritable non-volatile memory module;
a buffer memory; and
a memory management circuit, coupled to the host interface, the memory interface and the buffer memory,
wherein the memory management circuit is configured to receive a write command and write data corresponding to the write command,
wherein the memory management circuit is further configured to record physical-to-logical mapping information corresponding to the write data into a first mapping table temporarily stored in the buffer memory,
wherein the memory management circuit is further configured to send a write command sequence according to the first mapping table temporarily stored in the buffer memory to instruct for storing the physical-to-logical mapping information corresponding to the write data into a physical unit in the rewritable non-volatile memory module, wherein the physical unit is stored with at least partial data of the write data,
wherein the memory management circuit is further configured to update the physical-to-logical mapping information corresponding to the write data recorded in the first mapping table temporarily stored in the buffer memory, wherein the updated physical-to-logical mapping information only comprises partial information of the physical-to-logical mapping information corresponding to the write data,
wherein the memory management circuit is further configured to update a second mapping table according to the updated physical-to-logical mapping information recorded in the first mapping table.

20. The memory control circuit unit of claim 19, wherein the operation of recording the physical-to-logical mapping information corresponding to the write data into the first mapping table by the memory management circuit comprises:
reserving a first area in the first mapping table; and
recording the physical-to-logical mapping information corresponding to the write data into a second area in the first mapping table.

21. The memory control circuit unit of claim 20, wherein the operation of updating the physical-to-logical mapping information corresponding to the write data recorded in the first mapping table temporarily stored in the buffer memory by the memory management circuit comprises:
removing the physical-to-logical mapping information corresponding to the write data recorded in the second area; and
recording the updated physical-to-logical mapping information into the first area.

22. The memory control circuit unit of claim 19, wherein the write data comprises first write data and second write data,
wherein the operation of updating the physical-to-logical mapping information corresponding to the write data recorded in the first mapping table temporarily stored in the buffer memory by the memory management circuit comprises:
keeping the physical-to-logical mapping information corresponding to the first write data in the first mapping table; and
removing the physical-to-logical mapping information corresponding to the second write data from the first mapping table.

23. The memory control circuit unit of claim 22, wherein logical-to-physical mapping information of a logical unit for storing the second write data is temporarily stored in the buffer memory when the write command is received.

24. The memory control circuit unit of claim 19, wherein the first mapping table is a physical-to-logical mapping table, wherein the second mapping table is a logical-to-physical mapping table.

25. The memory control circuit unit of claim 19, wherein the operation of updating the physical-to-logical mapping information corresponding to the write data recorded in the first mapping table temporarily stored in the buffer memory is performed only when a data size of the updated physical-to-logical mapping information is not greater than a preset size.

26. The memory control circuit unit of claim 19, wherein the operation of updating the physical-to-logical mapping information corresponding to the write data recorded in the first mapping table temporarily stored in the buffer memory by the memory management circuit comprises:
determining whether logical-to-physical mapping information of at least one logical unit for storing the write data is temporarily stored in the buffer memory;
if the logical-to-physical mapping information of a logical unit for storing a first write data in the write data is not temporarily stored in the buffer memory, keeping the physical-to-logical mapping information corresponding to the first write data in the first mapping table; and
if the logical-to-physical mapping information of a logical unit for storing a second write data in the write data is temporarily stored in the buffer memory, removing the physical-to-logical mapping information corresponding to the second write data from the first mapping table.

27. The memory control circuit unit of claim 19, wherein the operation of updating the physical-to-logical mapping information corresponding to the write data recorded in the first mapping table temporarily stored in the buffer memory by the memory management circuit comprises:
determining whether multiple physical-to-logical mapping information of a same logical unit exists in the first mapping table temporarily stored in the buffer memory; and
if the multiple physical-to-logical mapping information of the same logical unit exists in the first mapping table temporarily stored in the buffer memory, keeping only one of the multiple physical-to-logical mapping information of the same logical unit in the first mapping table.
